(19) United States
(12) Patent Application Publication
(10) Pub. No.: US 2007/0102996 A1
(43) Pub. Date: May 10, 2007

(54) Hydraulic full power brake system for trailers

(75) Inventors: Ralph D. Kelly, Union, KY (US); Dirk Wohltmann, Birmingham, MI (US)

Correspondence Address: CARLSON, GASKEY & OLDS, P.C., 400 WEST MAPLE ROAD, SUITE 350, BIRMINGHAM, MI, 48009, US

(73) Assignee: Meritor WABCO Vehicle Control Systems

(21) Appl. No.: 11/272,547

(22) Filed: Nov. 10, 2005

(51) Int. Cl. B60T 13/74

(52) U.S. Cl. 303/3

(57) ABSTRACT

A trailer brake system includes a full power hydraulic brake system that is electrically controlled by a system control unit. The trailer brake system includes a power unit that maintains a pressurized supply of hydraulic fluid and a brake control unit that is fluidly connected between the power unit and trailer wheel brake components. The power unit includes an electric motor driven pump and accumulator that is in fluid communication with a trailer supply reservoir. The brake control unit includes an inlet valve that is fluidly connected to the accumulator and an outlet valve that is fluidly connected to the trailer supply reservoir. The system control unit generates control signals to the power unit and brake control unit to respectively maintain a desired pressure level in the accumulator, and to apply the trailer wheel brake components through the brake control unit.

### TECHNICAL FIELD

The subject invention relates to a hydraulic brake system for a trailer towed by a passenger car or light to medium duty truck where the hydraulic brake system is electronically controlled.

### BACKGROUND OF THE INVENTION

Light to medium duty vehicles, such as passenger cars, pick-up trucks, sport utility vehicles, etc., are often configured to pull trailers. These trailers are typically utility or work trailers but can include horse trailers and recreational trailers, such as campers, for example. These types of trailers typically include medium duty trailer brakes that are controlled by one of two different methods.

One method uses electronic control for actuating magnetic brakes at each trailer wheel. An electrical control signal is used to generate a magnetic brake actuation force. Another method uses hydraulic surge brake control to actuate hydraulic brakes. This is often referred to as a hydraulic over hydraulic system. During a braking event, a trailer tongue connection between the trailer and vehicle has a tendency to dive downwardly. Surge control recognizes this occurrence and utilizes hydraulic control to actuate the hydraulic brakes.

Each of these controls provides an effective method for stopping the trailer. However, neither method offers control for emergency stopping situations. In an emergency stopping situation a trailer has increased potential for jack-knifing or roll-over events. Further, neither method offers anti-lock control to prevent wheel lock-up under poor road conditions.

Thus, there is a need for a trailer brake system for light to medium duty vehicles that provides improved control for all stopping situations.

### SUMMARY OF THE INVENTION

The subject invention provides a full power hydraulic brake system for a trailer that is controlled by an electronic control unit (ECU). The trailer brake system includes a power unit that maintains a desired level of fluid pressure in the brake system, and a brake control unit that applies trailer wheel brakes in response to a braking request. The trailer brake system optionally includes an anti-lock brake system (ABS) control unit to prevent wheel lock-up.

The power unit includes an electric motor that is controlled by the ECU. The electric motor drives a pump to maintain a desired pressure level in an accumulator. The pump supplies hydraulic fluid to the accumulator from a trailer supply reservoir. The pressure in the accumulator is monitored and controlled by the ECU by using a pressure transducer. A pressure limiting valve prevents over-pressure conditions.

The brake control unit includes a pressure transducer, an inlet valve that is normally closed, and an outlet valve that is normally open during non-braking. The ECU controls brake pressure in a closed loop circuit with the pressure transducer and the inlet and outlet valves. In response to a braking request, the outlet valve is closed and the inlet valve is pulsed open until an appropriate pressure is provided to a trailer wheel brake component.

The ABS control unit includes wheel speed sensors for a least a right side wheel and a left side wheel. The wheel speed sensors communicate speed data to the ECU. The ABS control unit includes inlet and outlet valves for each of the right and left side wheels. The inlet valves are normally open and the outlet valves are normally closed. The ECU generates a control signal based on the speed data to close the inlet valves and open the outlet valves as needed to prevent wheel lock-up.

The trailer brake system optionally includes a parking brake that is preferably a spring applied hydraulic release (SAHR) brake. A park brake valve assembly is fluidly connected to the accumulator. The park brake valve assembly applies pressure to the SALR brake to release the parking brake and releases pressure from the SAHR brake to apply the parking brake.

These and other features of the present invention can be best understood from the following specification and drawings, the following of which is a brief description.

### BRIEF DESCRIPTION OF THE DRAWINGS

FIG. 1 is a schematic view of a vehicle towing a trailer incorporating the subject trailer brake system.

FIG. 2 is a schematic diagram of a trailer brake system incorporating the subject invention.

FIG. 3 is a schematic diagram showing system inputs and outputs.

### DETAILED DESCRIPTION OF THE PREFERRED EMBODIMENT

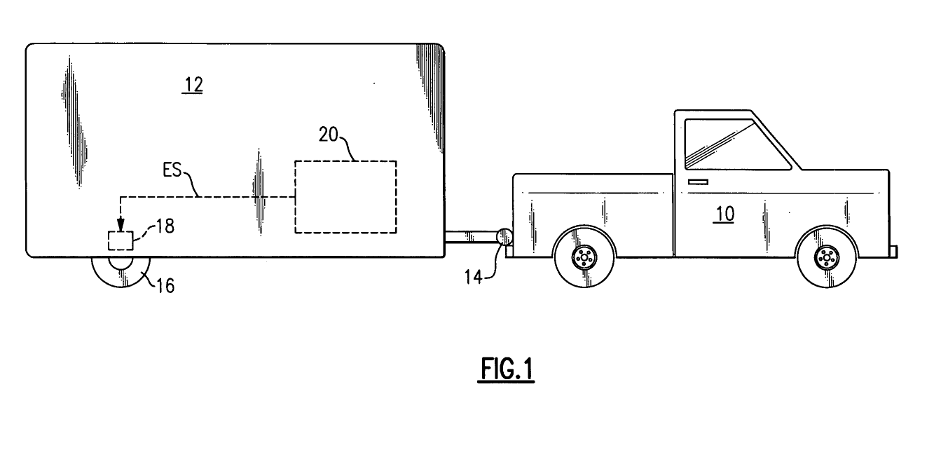

FIG. 1 shows a light to medium duty vehicle 10 that is connected to a trailer 12 with a hitch 14. Optionally, the trailer 12 could be towed through a fifth wheel connection (not shown). The trailer 12 includes at least one axle having a set of wheels 16 (only one wheel is shown in FIG. 1). The wheel 16 includes a wheel brake member, which is schematically indicated at 18. The wheel brake member 18 is preferably a disc brake with a caliper that is hydraulically actuated, however, other types of hydraulically actuated wheel brakes could also be used.

A trailer brake system 20 generates an electric control signal ES that is used to hydraulically actuate the wheel brake member 18 in response to a braking request. Thus, the trailer brake system 20 provides an electric over hydraulic system for the trailer 12.

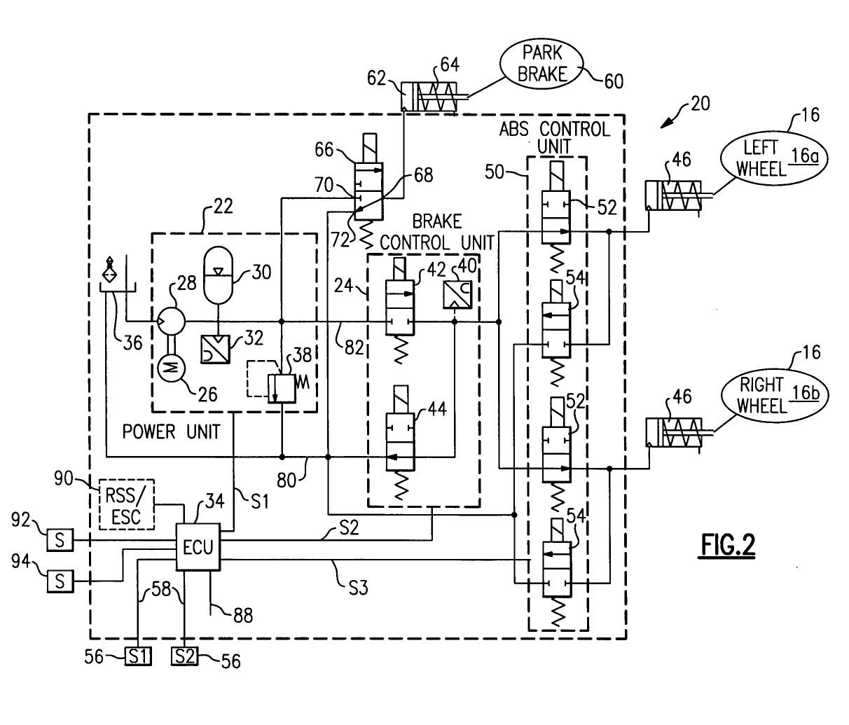

The trailer brake system 20 is shown in greater detail in FIG. 2. The trailer brake system includes a power unit 22 and a brake control unit 24. The power unit 22 includes an electric motor 26, a pump 28, an accumulator 30, and a pressure transducer 32. The trailer brake system 20 includes an electronic control unit (ECU) 34 that actuates the electric motor 26 to drive the pump 28 to maintain a desired fluid pressure within the accumulator 30. The pump 28 supplies fluid to the accumulator 30 from a trailer supply reservoir 36. The trailer supply reservoir 36 is preferably solely dedicated to the trailer brake system 20. The preferred fluid used in the system is DOT3 or DOT4 brake fluid, however, other brake fluids could also be used.

Pressure within the accumulator 30 is monitored and controlled by the ECU 34 by utilizing the pressure transducer 32. When pressure in the accumulator 30 falls below a predetermined minimum pressure or cut-in level, the ECU 34 generates a control signal S1 to actuate the electric motor 26 to drive the pump 28, which pumps fluid from the trailer supply reservoir 36 to the accumulator 30. A pressure limiting valve 38 prevents over-pressure situations, which could result in system damage.

The brake control unit 24 includes a pressure transducer 40, an inlet valve 42, and an outlet valve 44. The inlet valve 42 is normally closed and the outlet valve 44 is normally open during non-braking conditions. During a braking event, an electric voltage or current signal proportional to a requested brake pressure is used as an input to the ECU 34. The ECU 34 then controls brake pressure in a closed loop circuit with the pressure transducer 40 and the inlet 42 and outlet 44 valves. The ECU generates a control signal S2 such that the outlet valve 44 gets closed and the inlet valve 42 gets pulsed open until an appropriate pressure occurs in a brake circuit 46 at the wheel 16. To release the pressure, the inlet valve 42 is closed and the outlet valve 44 is opened.

In the example shown, the inlet valve 42 supplies fluid pressure to the brake circuit 46 for a left wheel 16a and for a right wheel 16b positioned laterally opposite the left wheel 16a. The trailer 12 could also include additional axles and wheels that may or may not have brake circuits 46.

The trailer brake system 20 could optionally include an anti-lock brake system (ABS) control unit 50. The ABS control unit 50 includes an inlet valve 52, an outlet valve 54, and a wheel speed sensor 56 that is associated with each wheel 16. Any type of wheel speed sensor 56 could be used such as tone wheel configuration, for example. The wheel speed sensors 56 generate signals 58 that transmit wheel speed data to the ECU 34.

The inlet valve 52 is normally open and the outlet valve 54 is normally closed. During an ABS event, such as slippery or other types of poor road conditions, the wheel 16 has a tendency to lock-up. The ECU 34 generates a control signal S3 to open and close the inlet 52 and outlet 54 valves as needed to prevent wheel lock-up.

If the trailer 12 includes more than two wheels, each additional wheel may or may not be provided with an ABS feature. Preferably, at least one wheel per side (right and left sides) of the trailer 12 is provided with the ABS feature.

The trailer brake system 20 could also optionally include a parking brake 60. The parking brake 60 is preferably a spring applied hydraulic release (SAHR) brake that has a chamber 62 and spring member 64. A parking valve assembly 66 is fluidly connected to the chamber 62 and to the accumulator 30. The parking valve assembly 66 is a 3/2 way valve, which has an outlet port 68 in fluid communication with the chamber 62, a supply port 70 in fluid communication with the accumulator 30, and a release port 72 in fluid communication with the trailer supply reservoir 36.

The parking valve assembly 66 releases pressure from the chamber 62 via the release port 72 during a park brake request, such that the spring member 64 applies the parking brake 60. To release the parking brake 60, pressure is supplied through the supply port 70 to the outlet port 68, to the chamber 62.

The parking brake 60 could be located at each wheel 16 on the trailer 12, or could only be located at one wheel 16 depending on application requirements. Further, a short time parking brake function could be supplied without have to incorporate a parking brake 60 into the trailer brake system 20. To apply a short time park brake request, the brake circuit 46 at each wheel 16 gets applied with a specified amount of pressure like in a normal brake situation.

As shown in FIG. 2, the pressure transducer 40 of the brake control unit 24 is located downstream of the inlet valve 42 and upstream of the ABS control unit 50. Further the pressure transducer 40 is also fluidly connected to a return line 80 that returns released fluid to the trailer supply reservoir 36. A supply line 82 fluidly connects the accumulator 30 to the inlet valve 42.

The ECU 34 is electrically connected to the power unit 22, the brake control unit 24, and the ABS control unit 50. The ECU is connected at 88 to a vehicle battery (not shown) or other power source.

Optionally, the trailer brake system 20 could include a roll stability system (RSS) control and/or an electronic stability control (ESC) 90. For RSS, the trailer brake system 20 would use available data from the system described above to identify potential roll-over events. The ECU 34 would control braking as need to prevent roll-over.

For ESC, in addition to using the available data, an accelerometer 92 and a yaw rate sensor 94 are required. The trailer brake system 20 uses information from these sensors 92, 94 to identify potential unstable driving conditions, and the ECU 34 would then generate control signals to control braking as needed to improve stability.

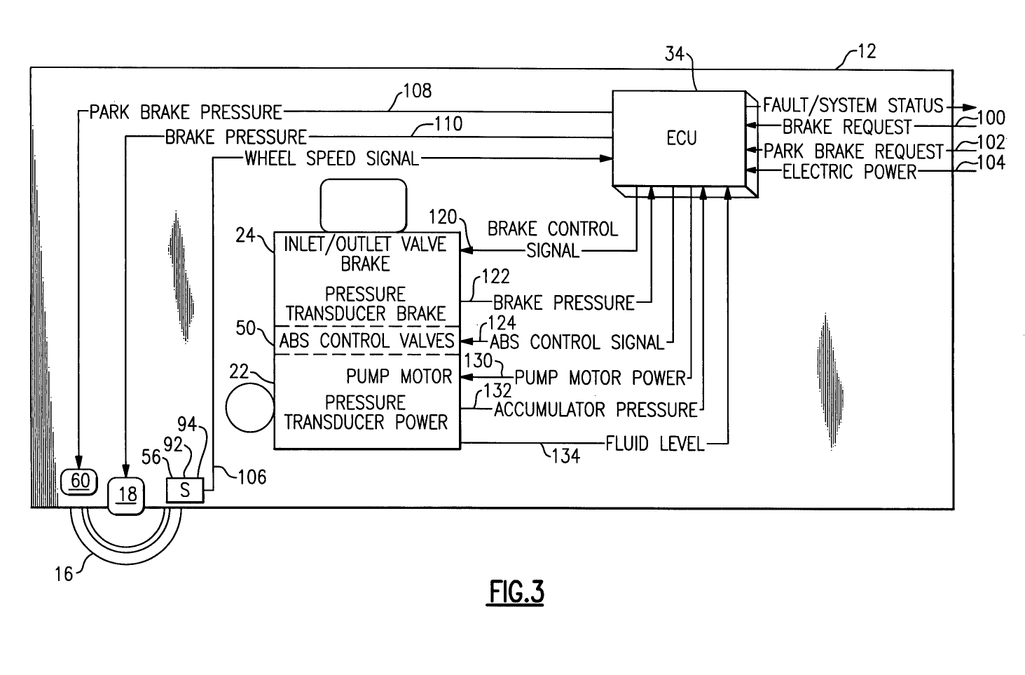

FIG. 3 shows a schematic diagram of system inputs and outputs. The ECU 34 receives inputs such as a brake request input 100, a park brake request input 102, an electric power input 104, and sensor inputs 106 for the sensors 56, 92, 94. In response to a park brake request, the ECU 34 generates a park brake pressure output 108 that is communicated to the parking brake 60. In response to a braking request, the ECU 34 generates a brake pressure output 110 that is communicated to the wheel brake member 18.

Various system inputs and outputs are also communicated between the ECU 34 and the power unit 22, brake control unit 24, and the ABS control unit 50. The ECU 34 communicates a brake control output 120 to the inlet 42 and outlet 44 valves of the brake control unit 24. The brake control unit 24 communicates a brake pressure signal 122 from the pressure transducer 40 to the ECU 34. The ECU 34 communicates a brake control output 124 to the inlet 52 and outlet 54 valves of the ABS control unit 50.

The ECU 34 communicates a pump motor power request 130 to the electric motor 26 of the power unit 22. The power unit 22 communicates an accumulator pressure output 132 to the ECU 34 via the pressure transducer 32. The power unit 22 also communicates fluid level output 134 to the ECU 34.

The subject invention provides a hydraulic full power brake system for a trailer towed by a light to medium duty vehicle, which provides several advantages over prior systems. The hydraulic full power brake system is a compact unit that is self-contained and easily installed on a trailer. High braking forces are provided when needed. Further, precise and controlled pressure applications are also provided during emergency stopping conditions. This reduces premature wear and tear on brake components and prevents high mechanical stresses for towing bar and other associated hitch components. Also, by having precise control over braking, the occurrence of undesirable conditions, such as jack-knifing and roll over for example, are significantly reduced.

It should be understood that the subject system could be controlled in various different manners. A driver could manually actuate a hand brake, lever, or switch to generate a braking request. Preferably, a pressure transducer (not shown) is used to determine rear axle brake pressure at the towing vehicle. In this situation, the pressure transducer is connected within a brake line to a master cylinder on the vehicle. Optionally, a connection between the trailer and the vehicle can be monitored to determine when a braking request should be generated.

Although a preferred embodiment of this invention has been disclosed, a worker of ordinary skill in this art would recognize that certain modifications would come within the scope of this invention. For that reason, the following claims should be studied to determine the true scope and content of this invention.

1. A trailer brake system comprising:
a trailer brake component adapted to directly brake a trailer wheel;
a brake control unit fluidly connected to said trailer brake component to hydraulically apply said trailer brake component in response to a braking request;
a power unit fluidly connected to said brake control unit to supply hydraulic fluid to said brake control unit; and
a system control unit electrically connected to said power unit and said brake control unit, said system control unit controlling said power unit to maintain a predetermined supply level of hydraulic fluid, and wherein said system control unit generates an electric control signal that is communicated to said brake control unit in response to the braking request to hydraulically apply said trailer brake component.

2. The trailer brake system according to claim 1 wherein an electric voltage or current signal proportional to a requested braking pressure comprises an input signal into the system control unit and wherein said electric control signal comprises an output signal from said system control unit that is based on said input signal.

3. The trailer brake system according to claim 1 wherein said brake control unit includes a pressure transducer, an inlet valve, and an outlet valve that cooperate with the system control unit to control brake pressure in a closed loop circuit.

4. The trailer brake system according to claim 3 wherein said inlet valve is normally closed and said outlet valve is normally open during non-braking operation and wherein said system control unit generates said electric control signal to open said inlet valve and close said output valve in response to the braking request.

5. The trailer brake system according to claim 1 wherein said power unit includes an electric motor, a pump driven by said electric motor, an accumulator having a predetermined pressure level, and a trailer supply reservoir fluidly connected to said accumulator wherein said system control unit controls said electric motor to drive said pump to supply hydraulic fluid from said trailer supply reservoir to said accumulator to maintain said predetermined pressure level.

6. The trailer brake system according to claim 5 wherein said power unit includes a pressure transducer in communication with said accumulator and said system control unit to maintain said predetermined pressure level, and includes a pressure limiting valve fluidly connected to said trailer supply reservoir and said pump to maintain pressure levels below a predetermined maximum pressure.

7. The trailer brake system according to claim 1 including an anti-lock brake control unit fluidly connected to said power unit and said brake control unit, said anti-lock brake control unit including an inlet valve, an outlet valve, and a wheel speed sensor associated with the trailer wheel to determine a speed of the trailer wheel wherein said inlet valve is normally open and said outlet valve is normally closed during non-braking with said system control unit controlling operation of said inlet and said outlet valves based on input from said wheel speed sensor to prevent wheel lock at the trailer wheel.

8. The trailer brake system according to claim 1 including a parking brake that is adapted to directly apply a parking brake force to the trailer wheel and a park brake valve assembly having an outlet port in fluid communication with said parking brake, a supply port in fluid communication with said power unit, and a release port in fluid communication with a trailer supply reservoir wherein the parking brake is applied by releasing pressure from the parking brake via the release port and the parking brake is released by supplying pressure through the supply port and out to the parking brake through the outlet port.

9. The trailer brake system according to claim 1 wherein the trailer wheel is adaptable to support a trailer towed by one of a passenger car, light duty vehicle, and medium duty vehicle.

10. A trailer brake system comprising:
a first trailer brake component adapted to directly brake a first trailer wheel;
a second trailer brake component adapted to directly brake a second trailer wheel that is positionable on an opposite side of a trailer from the first trailer wheel;
a brake control unit fluidly connected to said first and said second trailer brake components wherein said brake control unit includes a pressure transducer, an inlet valve, and an outlet valve that cooperate with each other to hydraulically apply said first and said second trailer brake components in response to a braking request;
a power unit fluidly connected to said brake control unit to supply hydraulic fluid to said brake control unit wherein said power unit includes an electric motor, a pump driven by said electric motor, an accumulator having a predetermined pressure level, and a trailer supply reservoir fluidly connected to said accumulator such that said electric motor drives said pump to maintain said accumulator at the predetermined pressure level by pumping fluid from the trailer supply reservoir to said accumulator; and
a system control unit electrically connected to said power unit and said brake control unit, said system control unit controlling said power unit to maintain a predetermined supply level of hydraulic fluid by actuating said electric motor, and wherein said system control unit generates an electric control signal that is communicated to said brake control unit in response to the braking request to hydraulically apply said first and said second trailer brake components.

11. The trailer brake system according to claim 10 wherein said inlet valve is normally closed and said outlet valve is normally open during non-braking operation and wherein said system control unit generates said electric control signal to open said inlet valve and close said output valve in response to the braking request.

12. The trailer brake system according to claim 11 wherein said power unit includes a pressure transducer in communication with said accumulator and said system control unit to maintain said predetermined pressure level, and a pressure limiting valve fluidly connected to said trailer supply reservoir and said pump to maintain pressure levels below a predetermined maximum pressure.

13. The trailer brake system according to claim 12 including an anti-lock brake control unit fluidly connected to said power unit and said brake control unit, said anti-lock brake control unit including a control valve assembly and a wheel speed sensor associated with each of the first and the second trailer wheels wherein each control valve assembly includes a first valve that is normally open and a second valve that is normally closed during non-braking with said system control unit controlling operation of said first and said second valves based on input from each of said wheel speed sensors to prevent wheel lock at the first and the second trailer wheels.

14. The trailer brake system according to claim 12 including a parking brake adapted to directly apply a parking brake force to the trailer wheel and a park brake valve assembly having an outlet port in fluid communication with said parking brake, a supply port in fluid communication with said accumulator, and a release port in fluid communication with said trailer supply reservoir wherein said parking brake is applied by releasing pressure from the parking brake via said release port and said parking brake is released by supplying pressure through said supply port and out to said parking brake through said outlet port.

15. A method for controlling a trailer brake system comprising the steps of:
(a) fluidly connecting a brake control unit to a trailer brake component such that the trailer brake component can be hydraulically applied in response to a braking request to directly brake a trailer wheel;
(b) fluidly connecting a power unit to the brake control unit to supply hydraulic fluid to the brake control unit;
(c) electrically connecting a system control unit to the power unit and controlling the power unit to maintain a predetermined supply level of hydraulic fluid; and
(d) electrically connecting the system control unit to the brake control unit and generating an electric control signal that is communicated to the brake control unit in response to the braking request to hydraulically apply the trailer brake component.

16. The method according to claim 15 including fluidly connecting an anti-lock brake control unit to the trailer brake component with the anti-lock brake control unit being positioned downstream of the brake control unit.

17. The method according to claim 15 including providing the power unit with an electric motor, a pump, an accumulator having a predetermined pressure level, and a trailer supply reservoir fluidly connected to the accumulator; and including maintaining the predetermined pressure level by generating a supply control signal from the system control unit to actuate the electric motor to drive the pump to supply hydraulic fluid from the trailer supply reservoir to the accumulator.

18. The method according to claim 15 including providing a pressure transducer, an inlet valve that is normally closed, and an outlet valve that is normally open in the brake control unit; and including fluidly connecting the pressure transducer to the inlet and outlet valves, electrically connecting the pressure transducer to the system control unit, and generating the electric control signal to open the inlet valve and close the output valve in response to the braking request.

19. The method according to claim 15 including selectively applying a parking brake that is fluidly connected to the power unit by releasing pressure from the parking brake via a park brake valve, and where the parking brake is directly applied to the trailer wheel.

20. The trailer brake system according to claim 1 wherein said trailer brake component only brakes the trailer wheel.

21. The trailer brake system according to claim 1 wherein the trailer wheel is supportable by a trailer axle and wherein said trailer brake component is mountable on a towable trailer supported by the trailer axle.

22. The trailer brake system according to claim 20 wherein said system control unit, said power unit, and said brake control unit cooperate to provide a trailer brake unit that is installable within a trailer to be towed by a vehicle.

23. The method according to claim 15 including forming the brake control unit, the power unit, and the system control unit as a trailer brake unit that is installable within a trailer to be towed by a vehicle.
